(19) United States
(12) Patent Application Publication
(10) Pub. No.: US 2014/0004292 A1
(43) Pub. Date: Jan. 2, 2014

(54) COMPOSITE MATERIALS

(71) Applicants: Lorin A. Mazur, Shelby Township, MI (US); Alex M. Kluge, Muncie, IN (US)

(72) Inventors: Lorin A. Mazur, Shelby Township, MI (US); Alex M. Kluge, Muncie, IN (US)

(73) Assignee: GM GLOBAL TECHNOLOGY OPERATIONS LLC, Detroit, MI (US)

(21) Appl. No.: 13/537,941

(22) Filed: Jun. 29, 2012

(51) Int. Cl. B32B 5/28

(52) U.S. Cl. 428/99; 428/159

(57) ABSTRACT

A composite material includes a first layer formed from a thermoformable reinforced thermoplastic composite consolidatable from an initial, lofted state having an initial thickness, to a substantially consolidated state having a final thickness that is less than the initial thickness. The material includes a second layer fused to the first and formed from an expanded polyolefin foam. The foam is compressible from an original form having an original average thickness to a compressed form having a final average thickness that is less than the original average thickness. The second layer has first and second regions in the compressed form. The first region has a first thickness that is less than the original average thickness. The second region has a second thickness that is greater than the first thickness and less than the original average thickness. The material is substantially free from an adhesive disposed between the first and second layers.

### TECHNICAL FIELD

The present disclosure generally relates to composite materials.

### BACKGROUND

Materials for vehicle components are generally selected according to the physical and/or chemical properties of the materials. That is, a material may be selected according to a weight, stiffness, density, and/or strength of the material. For example, to maximize vehicle fuel economy, the weight of a material may be considered. Likewise, to maximize component strength, the density and/or stiffness of a material may be considered.

### SUMMARY

A composite material includes a first layer and a second layer fused to the first layer. The first layer is formed from a thermoformable reinforced thermoplastic composite including a thermoplastic resin and a plurality of fibers dispersed within the thermoplastic resin. The thermoformable reinforced thermoplastic composite is consolidatable from an initial, lofted state having an initial thickness, to a substantially consolidated state having a final thickness that is less than the initial thickness. The second layer is formed from an expanded polyolefin foam. The expanded polyolefin foam is compressible from an original form having an original average thickness, to a compressed form having a final average thickness that is less than the original average thickness. Further, the second layer has a first region and a second region when the expanded polyolefin foam is disposed in the compressed form. The first region has a first thickness that is less than the original average thickness, and the second region has a second thickness that is greater than the first thickness and less than the original average thickness. In addition, the composite material is substantially free from an adhesive disposed between the first layer and the second layer.

In one embodiment, the thermoformable reinforced thermoplastic composite includes a polypropylene and a plurality of glass fibers dispersed within the polypropylene. Further, the second layer is formed from expanded polypropylene foam, and the expanded polypropylene foam is compressible from an original form having an original average thickness to a compressed form having a final average thickness that is less than the original average thickness. The second layer has a first region and a second region when the expanded polypropylene foam is disposed in the compressed form. The first region has a first thickness that is less than the original average thickness, and the second region has a second thickness that is greater than the first thickness and less than the original average thickness. Further, the first layer has a basis weight of less than or equal to about 500 g/m² when disposed in the substantially consolidated state, and the second layer has a basis weight of less than or equal to about 500 g/m² when disposed in the compressed form. In addition, a sum of the final thickness and the final average thickness is from about 5 mm to about 10 mm. The composite material also includes an attachment component formed from a polyolefin and bonded to the first layer.

A vehicle includes a body panel and a composite material attached to the body panel. The body panel has an exterior surface, and an interior surface spaced opposite the exterior surface. The composite material includes a first layer and a second layer fused to the first layer. The first layer is formed from a thermoformable reinforced thermoplastic composite including a thermoplastic resin and a plurality of fibers dispersed within the thermoplastic resin. The thermoformable reinforced thermoplastic composite is consolidatable from an initial, lofted state having an initial thickness, to a substantially consolidated state having a final thickness that is less than the initial thickness. The second layer is formed from an expanded polyolefin foam. The expanded polyolefin foam is compressible from an original form having an original average thickness to a compressed form having a final average thickness that is less than the original average thickness. Further, the second layer has a first region and a second region when the expanded polyolefin foam is disposed in the compressed form. The first region has a first thickness that is less than the original average thickness, and the second region has a second thickness that is greater than the first thickness and less than the original average thickness. In addition, the composite material is substantially free from an adhesive disposed between the first layer and the second layer.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic perspective illustration of a composite material;

FIG. 2 is a schematic perspective illustration of a secondary surface of the composite material of FIG. 1;

FIG. 3 is a schematic illustration of a side view of the composite material of FIG. 1;

FIG. 4A is a schematic perspective fragmentary illustration of a first layer and a second layer of the composite material of FIG. 1, wherein the first layer is disposed in an initial, lofted state, and the second layer is disposed in an original form;

FIG. 4B is a schematic perspective fragmentary illustration of the first layer and the second layer of the composite material of FIG. 1, wherein the first layer is disposed in a substantially consolidated state, and the second layer is disposed in a compressed form; and

FIG. 5 is a schematic perspective illustration of a vehicle including the composite material of FIG. 1.

### DETAILED DESCRIPTION

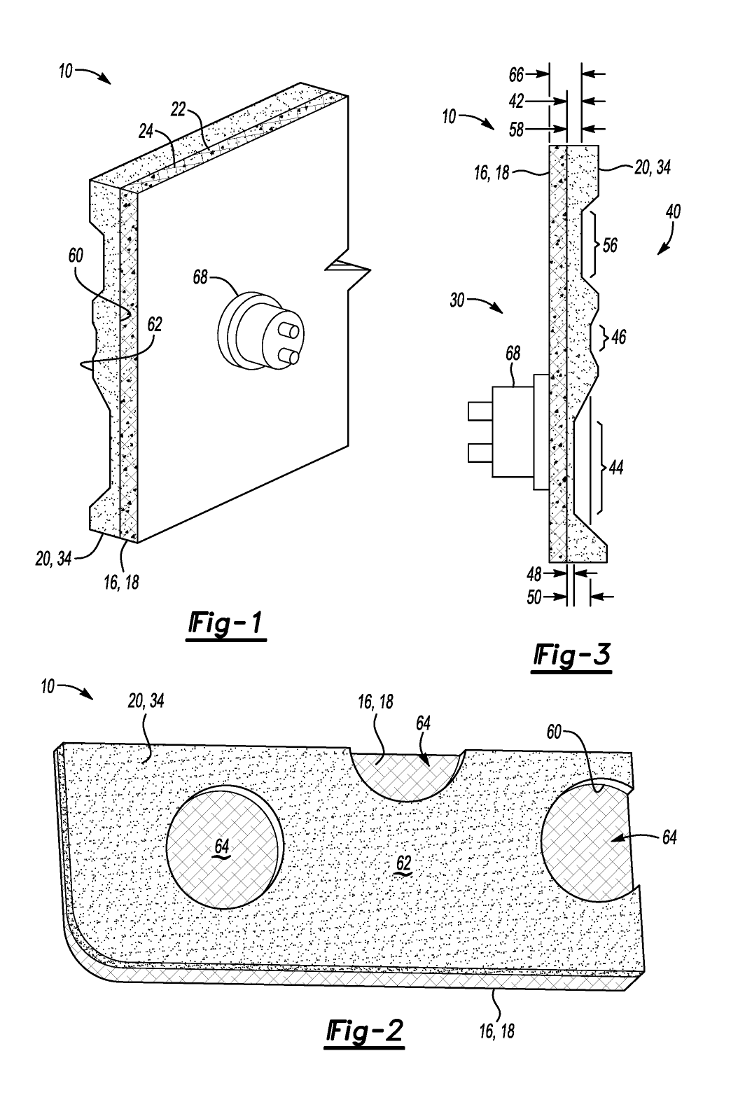

Referring to the Figures, wherein like reference numerals refer to like elements, a composite material is shown generally at 10 in FIG. 1. The composite material 10 may be useful for automotive applications requiring a lightweight, strong material. For example, the composite material 10 may be useful as insulation or as a structural material, and may be attached to a body panel 12 (FIG. 5) of a vehicle 14 (FIG. 5). In other non-limiting examples, the composite material 10 may be useful for forming a headliner (not shown), flooring panels (not shown), seat backings (not shown), and the like for automotive vehicles. However, the composite material 10 may also be useful for non-automotive applications including, but not limited to, construction, aviation, and marine applications.

Referring now to FIGS. 1 and 2, the composite material 10 includes a first layer 16 formed from a thermoformable reinforced thermoplastic composite 18. The first layer 16 may serve as a substrate for the composite material 10, and may be fused to another portion of the composite material 10, i.e., a second layer 20, as set forth in more detail below. Further, the first layer 16 may provide the composite material 10 with excellent strength at a minimal weight. In one embodiment, the thermoformable reinforced thermoplastic composite 18 may be referred to as a glass mat thermoplastic composite (GMT) or a lightweight reinforced thermoplastic composite (LRT), and may be commercially available from AZDEL, Inc. of Fenton, Mich., under the trade name SUPERLITE®.

As described with reference to FIG. 1, the thermoformable reinforced thermoplastic composite 18 includes a thermoplastic resin 22 and a plurality of fibers 24 dispersed within the thermoplastic resin 22. That is, the thermoplastic resin 22 may form a matrix, and the plurality of fibers 24 may be embedded in and dispersed throughout the matrix. Non-limiting examples of such thermoplastic resins 22 include polyolefins and thermoplastic polyolefin blends. For example, the thermoplastic resin 22 may be selected from the group of polypropylene, polyethylene, polymethylpentene, polybutene-1, and combinations thereof In one embodiment, the thermoplastic resin 22 is polypropylene. More specifically, the polypropylene may be a homopolymer, a random copolymer, a block copolymer, or combinations thereof.

With continued reference to FIG. 1, the plurality of fibers 24 may be suitable for combination with the thermoplastic resin 22. For example, each of the plurality of fibers 24 may be selected from the group consisting of natural fibers, glass fibers, mineral fibers, carbon fibers, metal fibers, ceramic fibers, and combinations thereof Non-limiting examples of natural fibers include fibers derived from plants or animals, wood, cotton, hemp, sisal, jute, flax, coir, kenaf, cellulosic fibers, and the like. Likewise, non-limiting examples of glass fibers include silica glass, E-glass, A-glass, E-CR-glass, C-glass, D-glass, R-glass, S-glass, and the like. As used herein, the terminology E-glass refers to an alumino-borosilicate glass having excellent resistivity. Further, as used herein, the terminology A-glass refers to an alkali-lime glass that is substantially free from boron oxide. As used herein, the terminology E-CR-glass refers to a corrosion-grade alumino-lime silicate glass having excellent corrosion-resistance to, for example, acids and alkalis. Further, as used herein, the terminology C-glass refers to an alkali-lime glass having excellent chemical resistance. As used herein, the terminology D-glass refers to a borosilicate glass having a comparatively high dielectric constant. Further, as used herein, the terminology R-glass refers to an alumino-silicate glass that is substantially free from magnesium oxide and calcium oxide, and exhibits excellent mechanical properties. As used herein, the terminology S-glass refers to an alumino-silicate glass that is substantially free from calcium oxide, includes magnesium oxide, and has excellent tensile strength and temperature-resistance. Further, non-limiting examples of mineral fibers include basalt, mineral wool, wollanstonite, alumina, and the like. Non-limiting examples of metal fibers include gold, silver, aluminum, metalized natural fibers, metalized synthetic fibers, and the like. Non-limiting examples of ceramic fibers may have a polycrystalline structure and may be formed from alumina, mullite, silicon carbide, zirconia, carbon, and combinations thereof. Non-limiting examples of carbon fibers include carbon graphite, graphite, and the like. In one embodiment, the plurality of fibers 24 may be glass fibers.

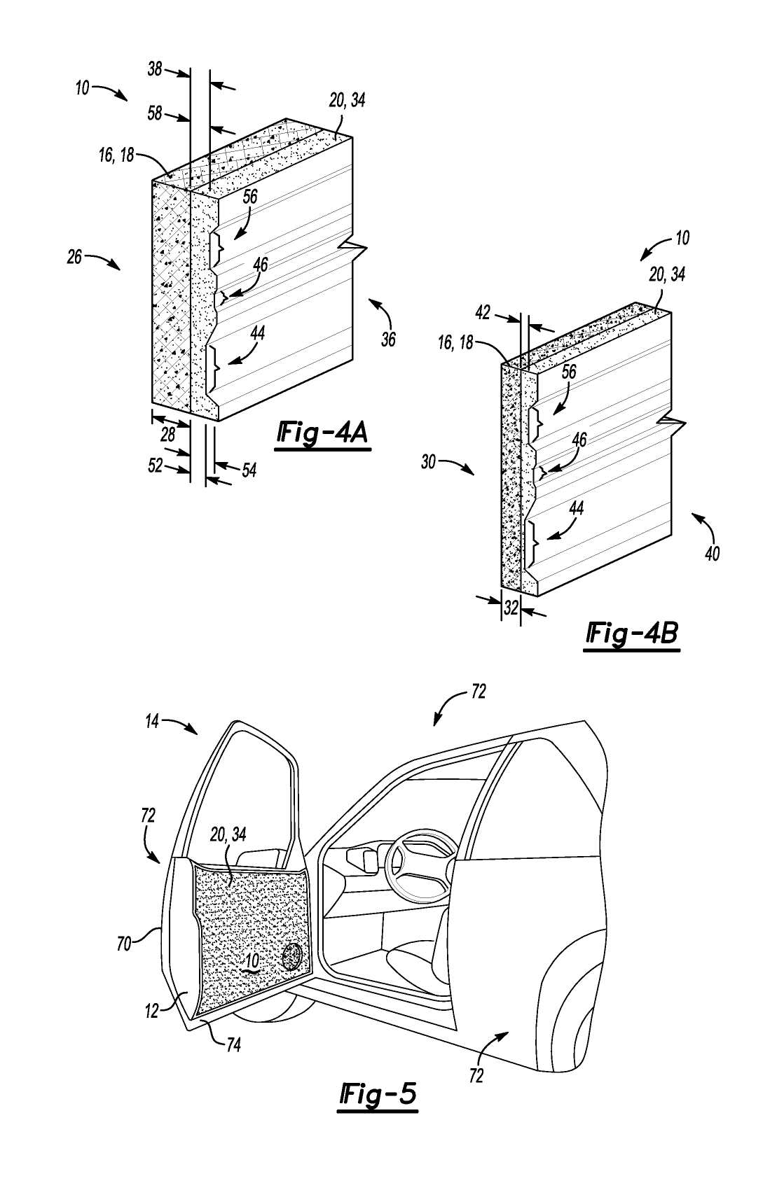

Referring now to FIGS. 4A and 4B, the thermoformable reinforced thermoplastic composite 18 is consolidatable from an initial, lofted state 26 (FIG. 4A) having an initial thickness 28 (FIG. 4A), to a substantially consolidated state 30 (FIG. 4B) having a final thickness 32 (FIG. 4B) that is less than the initial thickness 28. The thermoformable reinforced thermoplastic composite 18 may be produced by a wet-laid papermaking process. In particular, the thermoformable reinforced thermoplastic composite 18 may be formed as a fibrous wet web (not shown) and dried to form the thermoformable reinforced thermoplastic composite 18 disposed in the initial, lofted state 26. Upon compression, as set forth in more detail below, the initial, lofted state 26 may consolidate into the substantially consolidated state 30 so that the final thickness 32 is less than the initial thickness 28. For example, the initial thickness 28 may be from about 2 mm to about 4 mm, and the final thickness 32 may be from about 1 mm to about 3 mm. In addition, upon compression, the thermoformable reinforced thermoplastic composite 18 may increase in density by from about 10% to about 30%, e.g., about 20%. That is, a final density of the thermoformable reinforced thermoplastic composite 18 may be from about 10% to about 30% greater than an original density of the thermoformable reinforced thermoplastic composite 18. As such, the first layer 16 formed from the thermoformable reinforced thermoplastic composite 18 may have a greater final density when the thermoformable reinforced thermoplastic composite 18 is disposed in the substantially consolidated state 30 as compared to the initial density when the thermoformable reinforced thermoplastic composite 18 is disposed in the initial, lofted state 26. Therefore, the first layer 16 provides the composite material 10 with excellent stiffness.

As described with reference to FIG. 4B, the first layer 16 may have a basis weight of less than about 550 g/m² when the first layer 16 is disposed in the substantially consolidated state 30. For example, the first layer 16 may have a basis weight of from about 350 g/m² to about 500 g/m² when the first layer 16 is disposed in the substantially consolidated state 30. As used herein, the terminology “basis weight” refers to a paper density or an areal density of a material, and is expressed in units of weight per area.

Referring again to FIG. 1, the composite material 10 also includes the second layer 20 fused to the first layer 16 and formed from an expanded polyolefin foam 34. The second layer 20 may be configured to a desired shape, e.g., the shape of the body panel 12 (FIG. 5), and may provide the composite material 10 with excellent insulation and/or noise, vibration, and harshness characteristics. Further, the second layer 20 may fuse, i.e., non-adhesively bond, with the first layer 16, as set forth in more detail below, so as to minimize delamination of the first layer 16 from the second layer 20. Further, the second layer 20 may also provide the composite material 10 with excellent strength at a minimal weight.

With continued reference to FIG. 1, the expanded polyolefin foam 34 may be selected based on compatibility with the aforementioned thermoplastic resin 22. As such, suitable examples of expanded polyolefin foams 34 may include expanded polypropylene foam, expanded polyethylene foam, and combinations thereof. In one embodiment, the expanded polyolefin foam 34 is expanded polypropylene foam. That is, for the embodiment wherein the thermoplastic resin 22 is polypropylene, the expanded polyolefin foam 34 is expanded polyolefin foam. Likewise, for an embodiment wherein the thermoplastic resin 22 is polyethylene, the expanded polyolefin foam 34 is expanded polyethylene foam. Such compatibility between the thermoplastic resin 22 and the expanded polyolefin foam 34 contributes to the excellent fusion of the second layer 20 to the first layer 16.

Referring again to FIGS. 4A and 4B, the expanded polyolefin foam 34 is compressible from an original form 36 (FIG. 4A) having an original average thickness 38 (FIG. 4A) to a compressed form 40 (FIG. 4B) having a final average thickness 42 (FIG. 4B) that is less than the original average thickness 38. That is, the expanded polyolefin foam 34 is compressible, e.g., under heat and pressure, as set forth in more detail below. For example, the original average thickness 38 may be from about 5 mm to about 15 mm, and the final average thickness 42 may be from about 3 mm to about 8 mm. In one specific embodiment, the original average thickness 38 may be about 10 mm, and the final average thickness 42 may be about 5 mm. That is, the compressed form 40 may have a smaller final average thickness 42 than the original average thickness 38 of the expanded polyolefin foam 34. Further, a ratio of the original average thickness 38 to the final average thickness 42 may be from about 3:1 to about 1.25:1, e.g., about 2:1. In addition, upon compression, the expanded polyolefin foam 34 may increase in density by from about 50% to about 70%, e.g., about 60%. That is, a final density of the expanded polyolefin foam 34 may be from about 50% to about 70% greater than an original density of the expanded polyolefin foam 34. As such, the second layer 20 formed from the expanded polyolefin foam 34 may have a greater final density when the expanded polyolefin foam 34 is disposed in the compressed form 40 as compared to the initial density when the expanded polyolefin foam 34 is disposed in the original form 36. Therefore, the second layer 20 also provides the composite material 10 with excellent stiffness.

With continued reference to FIG. 1, the second layer 20 may be fused to the first layer 16 in any suitable manner to form the composite material 10. By way of a non-limiting example, the first layer 16 may be disposed adjacent the second layer 20, and the first and second layers 16, 20 may be heated under compression, e.g., to a temperature of from about 100° C. to about 200° C., and subsequently cooled to thereby fuse the second layer 20 to the first layer 16. More specifically, such heating under compression may melt the thermoplastic resin 22 and the expanded polyolefin foam 34, i.e., may melt the compatible polyolefin of the thermoplastic resin 22 and the expanded polyolefin foam 34, so that the first layer 16 is fused to the second layer 20 to thereby form the composite material 10.

As best shown in FIG. 3, the second layer 20 has a first region 44 and a second region 46 when the expanded polyolefin foam 34 is disposed in the compressed form 40. The first region 44 has a first thickness 48 that is less than the original average thickness 38 (FIG. 4A), and the second region 46 has a second thickness 50 that is greater than the first thickness 48 and less than the original average thickness 38. That is, the second layer 20 may have a plurality of regions 44, 46 each having a reduced thickness 48, 50 as compared to the original average thickness 38 of the second layer 20 before compression.

Referring now to FIGS. 4A and 4B, when the expanded polyolefin foam 34 is disposed in the original form 36 (FIG. 4A), the first region 44 may have a first, original thickness 52 (FIG. 4A). Similarly, when the expanded polyolefin foam 34 is disposed in the original form 36, the second region 46 may have a second, original thickness 54 (FIG. 4A) that is larger than the first, original thickness 52. In this embodiment, the original average thickness 38 of the second layer 20 is therefore equal to an average of the first, original thickness 52 and the second, original thickness 54.

Similarly, as best shown in FIG. 3, when the expanded polyolefin foam 34 is disposed in the compressed form 40, the final average thickness 42 may be equal to an average of the first thickness 48 and the second thickness 50. Stated differently, when the expanded polyolefin foam 34 is disposed in the compressed form 40, the second layer 20 may have regions 44, 46 of different thicknesses 48, 50. Such regions 44, 46 may therefore be tailored according to the desired application of the composite material 10. For example, the second region 46 may provided increased structure and/or strength to the composite material 10 in a discrete or targeted area of the composite material 10 as compared to the first region 44.

With continued reference to FIG. 3, the first thickness 48 may be from about 1 mm to about 5 mm, e.g., about 3 mm. Further, the second thickness 50 may be from about 5 mm to about 10 mm, e.g., about 7 mm. In addition, the second layer 20 may have a basis weight of less than about 500 g/m² when the second layer 20 is disposed in the compressed form 40. For example, the second layer 20 may have a basis weight of from about 300 g/m² to about 450 g/m² when the second layer 20 is disposed in the compressed form 40.

Referring again to FIG. 3, it is to be appreciated that, for the embodiment including expanded polypropylene foam 34, the second layer 20 may further include a third region 56 when the expanded polypropylene foam 34 is disposed in the compressed form 40. For this embodiment, the third region 56 has a third thickness 58 that is greater than the first thickness 48 and less than the second thickness 50. That is, the second layer 20 may have more than two regions 44, 46, e.g., three or more regions 44, 46, 56, of differing respective thicknesses 48, 50, 58. Therefore, although not shown, it is to be appreciated that for this embodiment, the final average thickness 42 is equal to an average of the first thickness 48, the second thickness 50, and the third thickness 58. Again, such regions 44, 46, 56 may provide the composite material 10 with excellent strength and/or rigidity in specific selected locations of the composite material 10.

Referring now to FIGS. 1 and 2, the second layer 20 may have a primary surface 60 disposed adjacent the first layer 16, and a secondary surface 62 spaced opposite the primary surface 60. That is, the secondary surface 62 may form an outer surface of the composite material 10. As best shown in FIG. 2, the second layer 20 may define at least one bore 64 extending through the primary surface 60 and the secondary surface 62. That is, the at least one bore 64 may extend through the second layer 20 in a direction substantially perpendicular to a plane of the primary surface 60. Further, the at least one bore 64 may not extend into the first layer 16. That is, the first layer 16 may not define the at least one bore 64. As such, for automotive applications, the at least one bore 64 defined by the second layer 20 may be configured to house and/or contact additional components (not shown) of the vehicle 14 (FIG. 5), such as, but not limited to, wiring harnesses, structural steel, electronics, and the like.

Further, as best shown in FIG. 3, the composite material 10 is substantially free from an adhesive (not shown) disposed between the first layer 16 and the second layer 20. That is, as set forth above, the second layer 20 is fused, e.g., non-adhesively bonded, to the first layer 16. As such, the composite material 10 does not require or include an adhesive (not shown) to bond together the first and second layers 16, 20. Therefore, the composite material 10 minimizes material costs, minimizes production complexity, and increases production efficiency.

Referring again to FIG. 4B, the composite material 10 has a basis weight of less than about 1,000 g/m² when the first layer 16 is disposed in the substantially consolidated state 30 and the second layer 20 is disposed in the compressed form 40. In one non-limiting example, the composite material 10 may have a basis weight of from about 750 g/m² to about 900 g/m². As such, the composite material 10 is lightweight and suitable for applications requiring strength at a decreased mass.

In addition, referring again to FIG. 3, the composite material 10 may have an overall average thickness 66 equal to a sum of the final thickness 32 (FIG. 4B) and the final average thickness 42 (FIG. 4B). The overall average thickness 66 may be from about 5 mm to about 15 mm, e.g., from about 6 mm to about 9 mm. As such, the composite material 10 is suitable for applications requiring strength at a decreased thickness.

Referring again to FIGS. 1 and 3, in one embodiment, the composite material 10 further includes an attachment component 68 formed from a polyolefin and bonded to the first layer 16. The polyolefin may be selected from the group consisting of polypropylene, polyethylene, polymethylpentene, polybutene-1, and combinations thereof. Further, the polyolefin may be selected according to the selection of the thermoplastic resin 22 and/or the expanded polyolefin foam 34. That is, the attachment component 68, thermoplastic resin 22, and expanded polyolefin foam 34 may be formed from the same polyolefin. Such selection facilitates bonding of the attachment component 68 to the first layer 16. For example, the attachment component 68 may be fused, i.e., non-adhesively bonded, to the first layer 16. That is, the polyolefin of the attachment component 68 may be heated and compressed onto the first layer 16 so as to melt and fuse together the compatible polyolefin of both the attachment component 68 and the first layer 16. In one non-limiting example, the attachment component 68 may be configured for attachment to the vehicle 14 (FIG. 5), and may be formed from polypropylene. That is, the attachment component 68 may project from the first layer 16 for attachment to the vehicle 14 as, for example, a plug or a clip. Further, although not illustrated, the attachment component 68 may bond to the first layer 16 at an interface between the first layer 16 and the second layer 20. That is, although not shown, the attachment component 68 may bond to the first layer 16, extend through the at least one bore 64 defined by the second layer 20, and thereby project from the first layer 16 through the second layer 20 for attachment to the vehicle 14.

Referring now to FIG. 5, the vehicle 14 includes the body panel 12 having an exterior surface 70, which may form an exterior 72 of the vehicle 14, and an interior surface 74 spaced opposite the exterior surface 70. The exterior surface 70 may be referred to as a “Class A” surface. As used herein, the terminology “Class A” refers to an appearance surface finish which is viewable by a vehicle user during ordinary vehicle use. Therefore, as compared to components suitable for forming or attachment to the interior surface 74 of the vehicle 14, a component having a “Class A” surface finish generally has a comparatively higher distinctness of image and gloss. As such, “Class A” surfaces generally face an observer of the vehicle 14 who is positioned external to the vehicle 14. In contrast, the interior surface 74 may be covered by an insulative and/or structural component, e.g., the composite material 10.

Further, with continued reference to FIG. 5, the vehicle 14 includes the composite material 10 attached to the body panel 12. The composite material 10 may be attached to the body panel 12 via any suitable attachment device and/or method. For example, the composite material 10 may be attached to the body panel 12 via the attachment component 68 (FIG. 1). That is, as set forth above, the composite material 10 may further include the attachment component 68 configured for attaching the composite material 10 to the body panel 12 and formed from a polyolefin.

The composite material 10 exhibits excellent basis weight and minimized overall average thickness 66 (FIG. 3), and provides a lightweight, strong material for insulative or structural components of the vehicle 14 (FIG. 5). In particular, the first layer 16 (FIG. 1) has a reduced final thickness 32 (FIG. 4B) when disposed in the substantially consolidated state 30 (FIG. 4B), and as such, may be useful for vehicle components, e.g., the body panel 12 (FIG. 5), requiring impact resistance or energy absorption during use of the vehicle 14. The first layer 16 is also bondable to the attachment component 68 (FIG. 1) so as to minimize formation steps of the composite material 10. Further, the second layer 20 (FIG. 1) also exhibits excellent basis weight and provides structure to the composite material 10. That is, the second layer 20 may provide added strength in specific regions 44, 46 so that the composite material 10 is customizable for numerous vehicle components. Therefore, the strength and structure of the second layer 20 may be tailored. The second layer 20 may also provide torsional support to the composite material 10, and may aid in noise, vibration, and harshness abatement for the vehicle 14.

While the best modes for carrying out the disclosure have been described in detail, those familiar with the art to which this disclosure relates will recognize various alternative designs and embodiments for practicing the disclosure within the scope of the appended claims.

1. A composite material comprising:
a first layer formed from a thermoformable reinforced thermoplastic composite including a thermoplastic resin and a plurality of fibers dispersed within the thermoplastic resin;
wherein the thermoformable reinforced thermoplastic composite is consolidatable from an initial, lofted state having an initial thickness, to a substantially consolidated state having a final thickness that is less than the initial thickness; and
a second layer fused to the first layer and formed from an expanded polyolefin foam;
wherein the expanded polyolefin foam is compressible from an original form having an original average thickness to a compressed form having a final average thickness that is less than the original average thickness;
wherein the second layer has a first region and a second region when the expanded polyolefin foam is disposed in the compressed form;
wherein the first region has a first thickness that is less than the original average thickness, and the second region has a second thickness that is greater than the first thickness and less than the original average thickness;
wherein the composite material is substantially free from an adhesive disposed between the first layer and the second layer.

2. The composite material of claim 1, wherein the expanded polyolefin foam is expanded polypropylene foam.

3. The composite material of claim 2, wherein the thermoplastic resin is polypropylene.

4. The composite material of claim 1, wherein each of the plurality of fibers is selected from the group consisting of natural fibers, glass fibers, mineral fibers, carbon fibers, metal fibers, ceramic fibers, and combinations thereof.

5. The composite material of claim 1, wherein the first layer is disposed in the substantially consolidated state and has a basis weight of less than about 550 g/m².

6. The composite material of claim 1, wherein the second layer is disposed in the compressed form and has a basis weight of less than about 500 g/m².

7. The composite material of claim 1, wherein the composite material has a basis weight of less than about 1,000 g/m² when the first layer is disposed in the substantially consolidated state and the second layer is disposed in the compressed form.

8. The composite material of claim 1, wherein the second layer has a primary surface disposed adjacent the first layer, and a secondary surface spaced opposite the primary surface, and further wherein the second layer defines at least one bore extending through the primary surface and the secondary surface.

9. The composite material of claim 1, wherein the final average thickness is equal to an average of the first thickness and the second thickness, wherein the composite material has an overall average thickness equal to a sum of the final thickness and the final average thickness, and further wherein the overall average thickness is from about 5 mm to about 15 mm.

10. The composite material of claim 1, wherein the original average thickness is from about 5 mm to about 15 mm.

11. The composite material of claim 10, wherein the first thickness is from about 1 mm to about 5 mm.

12. The composite material of claim 11, wherein the second thickness is from about 5 mm to about 10 mm.

13. The composite material of claim 12, wherein the final average thickness is from about 3 mm to about 8 mm.

14. The composite material of claim 1, wherein a ratio of the original average thickness to the final average thickness is from about 3:1 to about 1.25:1.

15. A composite material comprising:
a first layer formed from a thermoformable reinforced thermoplastic composite including a polypropylene and a plurality of glass fibers dispersed within the polypropylene;
wherein the thermoformable reinforced thermoplastic composite is consolidatable from an initial, lofted state having an initial thickness, to a substantially consolidated state having a final thickness that is less than the initial thickness; and
a second layer fused to the first layer and formed from an expanded polypropylene foam;
wherein the expanded polypropylene foam is compressible from an original form having an original average thickness to a compressed form having a final average thickness that is less than the original average thickness;
wherein the second layer has a first region and a second region when the expanded polypropylene foam is disposed in the compressed form;
wherein the first region has a first thickness that is less than the original average thickness, and the second region has a second thickness that is greater than the first thickness and less than the original average thickness;
wherein the composite material is substantially free from an adhesive disposed between the first layer and the second layer;
wherein the first layer has a basis weight of less than or equal to about 500 g/m² when disposed in the substantially consolidated state;
wherein the second layer has a basis weight of less than or equal to about 500 g/m² when disposed in the compressed form;
wherein a sum of the final thickness and the final average thickness is from about 5 mm to about 10 mm; and
an attachment component formed from a polyolefin and bonded to the first layer.

16. The composite material of claim 15, wherein the second layer further includes a third region when the expanded polypropylene foam is disposed in the compressed form, wherein the third region has a third thickness that is greater than the first thickness and less than the second thickness.

17. The composite material of claim 15, wherein the attachment component is configured for attachment to a vehicle and formed from polypropylene.

18. A vehicle comprising:
a body panel having an exterior surface, and an interior surface spaced opposite the exterior surface; and
a composite material attached to the body panel and including:
a first layer formed from a thermoformable reinforced thermoplastic composite including a thermoplastic resin and a plurality of fibers dispersed within the thermoplastic resin;
wherein the thermoformable reinforced thermoplastic composite is consolidatable from an initial, lofted state having an initial thickness, to a substantially consolidated state having a final thickness that is less than the initial thickness; and
a second layer fused to the first layer and formed from an expanded polyolefin foam;
wherein the expanded polyolefin foam is compressible from an original form having an original average thickness to a compressed form having a final average thickness that is less than the original average thickness;
wherein the second layer has a first region and a second region when the expanded polyolefin foam is disposed in the compressed form;
wherein the first region has a first thickness that is less than the original average thickness, and the second region has a second thickness that is greater than the first thickness and less than the original average thickness;
wherein the composite material is substantially free from an adhesive disposed between the first layer and the second layer.

19. The vehicle of claim 1, wherein the composite material further includes an attachment component configured for attaching the composite material to the body panel and formed from a polyolefin.
